(19) United States
(12) Patent Application Publication
(10) Pub. No.: US 2008/0102823 A1
(43) Pub. Date: May 1, 2008

(54) SYSTEM AND METHOD FOR MANAGING POWER OF DBDM TERMINAL

(75) Inventor: Yong Bok LEE, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/775,769

(22) Filed: Jul. 10, 2007

(30) Foreign Application Priority Data
Oct. 31, 2006 (KR) 2006-0106501

(51) Int. Cl. H04Q 7/20

(52) U.S. Cl. 455/426.1; 455/574

(57) ABSTRACT

A method and a system for managing the power of a DBDM terminal. The method includes monitoring an event occurring when a portable terminal enters into a portable Internet mode; checking a power saving mode when occurrence of the event has been detected; transmitting phone information regarding the portable terminal to the mobile communication base station and the portable Internet base station when a phone on/off mode has been confirmed to be the power saving mode, interrupting power supply to the mobile communication unit of the portable terminal, and entering into a portable Internet mode; monitoring an incoming call request in the portable Internet mode; and supplying power to the mobile communication unit and entering into a mobile communication mode when the incoming call request has been detected.

### PRIORITY

This application claims priority under 35 U.S.C. §119(a) to an application filed in the Korean Intellectual Property Office on Oct. 31, 2006 and assigned Serial No. 2006-0106501, the contents of which are incorporated herein by reference.

### BACKGROUND OF THE INVENTION

1. Field of the Invention

The present invention generally relates to a Dual Band Dual Mode (DBDM) terminal and, more particularly, to a method and a system for extending the battery life of a DBDM terminal using mobile communication and portable Internet services.

2. Description of the Related Art

Recently, a hot spot service has been provided via a public wireless Local Area Network (LAN) to enable high-speed Internet access from public places by using laptop computers, for example. Such an Internet access service based on the public wireless LAN provides almost the same quality as in wired environments at a lower cost. However, this type of service has a problem of narrow coverage and poor mobility. As a result, there are limitations in providing a reliable and faultless service outdoors. In an attempt to solve the problem of such wireless LAN systems, a Wireless Broadband (WiBro) service named Portable Internet has been developed as a wireless Internet service for providing users on the move, as well as those remaining still, with high-speed Internet access with high service quality at a low cost. More particularly, a WiBro service refers to a service for enabling moving users, as well as stationary users, to wirelessly access Internet at a high speed regardless of time and place.

However, when a conventional DBDM portable terminal having functional modules adapted for the Portable Internet service and a conventional mobile communication service, respectively, is used for the portable Internet service, power is still supplied to the functional module adapted for the mobile communication service. This increases power consumption and shortens the battery life.

### SUMMARY OF THE INVENTION

The present invention addresses at least the above-described problems and/or disadvantages, and provides a system and a method for lengthening the battery life of a DBDM terminal by limiting power supply to an idle module.

In accordance with an aspect of the present invention, there is provided a system for managing power of a portable terminal for using a mobile communication service and a portable Internet service, the system including a portable terminal having a mobile communication unit and a portable Internet unit for using a mobile communication service and a portable Internet service, respectively, the portable terminal transmitting phone information and interrupting power supply to the mobile communication unit when the portable Internet service is used in a phone on/off mode; a portable Internet base station for receiving the phone information from the portable terminal, storing the phone information, and transmitting the stored phone information; and a mobile communication base station for receiving the phone information from the portable Internet base station and the portable terminal, storing the phone information, receiving a call connection request from a different portable terminal, and transmitting the received call connection request, wherein the portable terminal is adapted to resume power supply to the mobile communication unit when the portable Internet base station receives the call connection request and transmits the received call connection request to the portable terminal.

The portable terminal is adapted to interrupt power supply to the mobile communication unit when the portable Internet service is used in a phone off mode and resume power supply to the mobile communication unit when the portable Internet service is terminated.

In accordance with another aspect of the present invention, there is provided an apparatus for managing power of a portable terminal for using a mobile communication service and a portable Internet service by using a mobile communication base station and a portable Internet base station, the apparatus including a mobile communication unit for transmitting/receiving a mobile communication signal according to a protocol defined by a mobile communication service specification; a portable Internet unit for transmitting/receiving a portable Internet signal according to a protocol defined by a portable Internet service specification; and a control unit for transmitting phone information to a mobile communication network and the portable Internet base station and interrupting power supply to the mobile communication unit when a portable Internet mode is selected, the control unit resuming power supply to the mobile communication unit when an incoming call request regarding the mobile communication service is received from the portable Internet base station.

The control unit is adapted to limit power supply to the mobile communication unit when the portable Internet mode is selected and resume power supply to the mobile communication unit when the portable Internet mode is terminated.

In accordance with another aspect of the present invention, there is provided a method for managing power of a portable terminal for using a mobile communication service and a portable Internet service by using a mobile communication base station and a portable Internet base station, the method including monitoring an event occurring when the portable terminal enters into a portable Internet mode; checking a power saving mode when occurrence of the event has been detected; transmitting phone information regarding the portable terminal to the mobile communication base station and the portable Internet base station when a phone on/off mode has been confirmed to be the power saving mode, interrupting power supply to the mobile communication unit of the portable terminal, and entering into a portable Internet mode; monitoring an incoming call request in the portable Internet mode; and supplying power to the mobile communication unit and entering into a mobile communication mode when the incoming call request has been detected.

The method further includes checking a power saving mode when occurrence of the event has been detected; interrupting power supply to the mobile communication unit of the portable terminal and entering into the portable Internet mode when a phone off mode has been confirmed to be the power saving mode; and resuming power supply to the mobile communication unit when the portable Internet mode is terminated.

In accordance with another aspect of the present invention, there is provided a method for managing power of a portable terminal for using a mobile communication service and a portable Internet service, the method including monitoring an event occurring when a portable Internet service is provided by a portable terminal; checking a power saving mode when occurrence of the event is detected by the portable terminal; transmitting phone information and interrupting power supply to the mobile communication unit when a phone on/off mode has been confirmed to the power saving mode by the portable terminal; receiving the phone information regarding the portable terminal, storing the phone information, and transmitting the stored phone information by a portable Internet base station; receiving the phone information from the portable Internet base station and storing the phone information by a mobile communication base station; monitoring a call connection request of a different portable terminal by the mobile communication base station; transmitting the call connection request when the mobile communication base station has detected the call connection request; receiving the call connection request and transmitting the received call connection request by the portable Internet base station; and receiving the call connection request and resuming power supply to the mobile communication unit by the portable terminal.

Preferably, the phone information includes information necessary to identify the portable terminal and information necessary to identify a base station connected to the portable terminal.

### BRIEF DESCRIPTION OF THE DRAWINGS

The above and other objects, features and advantages of the present invention will be more apparent from the following detailed description in conjunction with the accompanying drawings, in which:

FIG. 1 is a block diagram of a portable terminal according to the present invention;

FIG. 2 shows a screen for setting up the condition of a portable terminal according to the present invention;

FIGS. 3a and 3b show the operation of an apparatus for saving the power of a portable terminal according to the present invention; and

FIG. 4 shows the operation of a portable terminal, a portable Internet base station, and a mobile communication base station according to the present invention.

### DETAILED DESCRIPTION OF THE PREFERRED EMBODIMENTS

Preferred embodiments of the present invention are described below with reference to the accompanying drawings. The same reference symbols identify the same or corresponding elements in the drawings. Descriptions of constructions or processes known in the art may be omitted to avoid obscuring the invention in unnecessary detail.

It will be assumed in the following description of the present invention that a portable terminal refers to a Dual Band Dual Mode (DBDM) portable terminal adapted for both a mobile communication service and a portable Internet service, such as a mobile communication terminal, a digital broadcasting terminal, a Personal Digital Assistant (PDA), a smart phone, an International Mobile Telecommunication 2000 (IMT-2000) terminal, a Wideband Code Division Multiple Access (WCDMA) terminal, a Universal Mobile Telecommunication Service (UMTS) terminal, or a Global System for Mobile Communications (GSM) Terminal. In other words, the present invention is applicable to any type of portable terminal (e.g. information communication device, multimedia device, etc.), which has functional modules adapted for a mobile communication service and a portable Internet service, respectively.

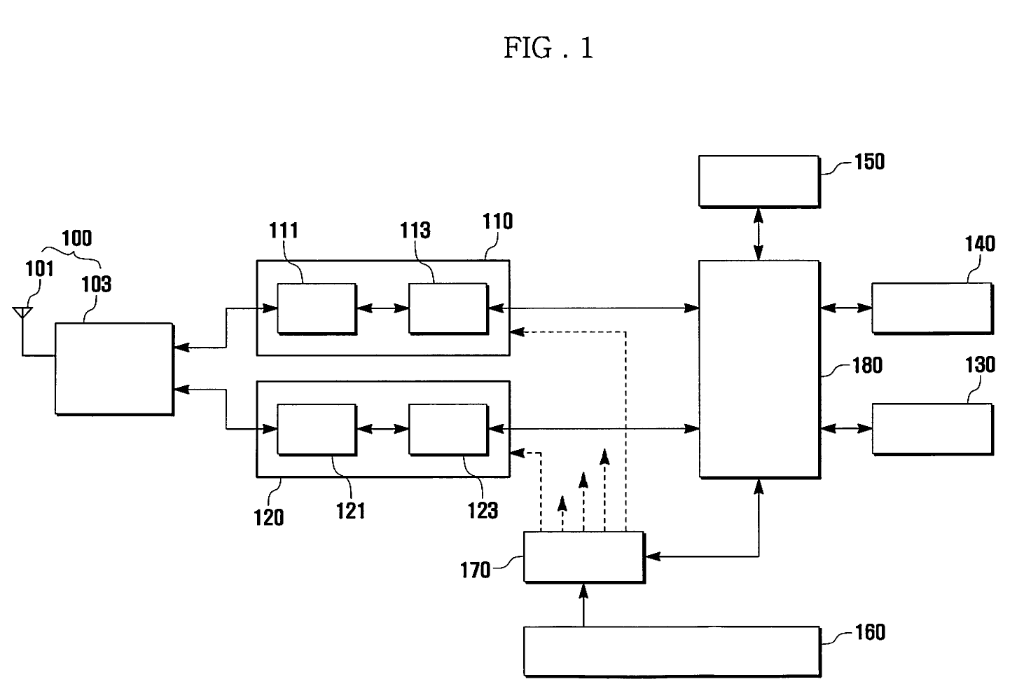

FIG. 1 shows a portable terminal according to the present invention. The portable terminal in FIG. 1 includes an antenna unit 100, a mobile communication unit 110, a portable Internet unit 120, a storage unit 130, an input unit 140, a display unit 150, a battery unit 160, a power supply unit 170, and a control unit 180.

The antenna unit 100 includes a Radio Frequency (RF) antenna 101 and an antenna filter 103. The RF antenna 101 receives RF signals from an adjacent mobile communication and/or portable Internet base stations and transmits them to the antenna filter 103. In addition, the antenna unit 100 receives RF signals from the antenna filter 103 and transmits them. As such, the antenna unit 100 transmits/receives mobile communication signals and/or portable Internet signals. The antenna filter 103 classifies RF signals, which have been received from the RF antenna 101, into mobile communication signals and portable Internet signals according to the frequency, and transmits them to the mobile communication unit 110 and the portable Internet unit 120, respectively. The mobile communication service and the portable Internet service use different frequency bands. For example, CDMA and Wireless Broadband (WiBro) use a frequency band of 800 MHz and 2.3 GHz, respectively. Considering this, the antenna filter 103 may include a suitable combination of a Band Pass Filter (BPF), a High Pass Filter (HPF), and a Low Pass Filter (LPF). It is also possible to connect diplexers and constitute the antenna filter 203 so two types of signals are separated and used for corresponding functions. Although a single RF antenna 101 is shown in FIG. 1, the number is not limited to that and may vary according to the present invention. For example, the mobile communication unit 110 and the portable Internet unit 120 may have respective RF antennas.

The mobile communication unit 110 includes a mobile communication RF module 111 and a mobile communication modem 113. The mobile communication RF module 111 demodulates mobile communication signals, which have been received from the antenna filter 103, and transmits the demodulated signals to the mobile communication modem 113. In addition, the mobile communication RF module 111 modulates transmission data, which have been received from the mobile communication modem 113, and transmits the modulated signals via the RF antenna 101. The mobile communication modem 113 processes mobile communication signals, which are received from the mobile communication RF module 111, and conducts a call proceeding according to a protocol based on mobile communication specifications.

The portable Internet unit 120 includes a portable Internet RF module 121 and a portable Internet modem 123. The portable Internet RF module 121 demodulates portable Internet signals, which have been received from the antenna filter 103, and transmits the demodulated signals to the portable Internet modem 123. The portable Internet unit 120 modulates transmission data, which has been received from the portable Internet modem 123, and transmits the modulated signals via the RF antenna 101. The portable Internet modem 123 processes portable Internet signals, which are received from the portable Internet RF module 121, and conducts a call proceeding according to a protocol based on portable Internet specifications. When the portable terminal functions in one of a mobile communication mode and a portable Internet mode under the control of the control unit 180 (described later), one of the modems 113 and 123, which processes signals in the corresponding mode, initializes the corresponding network. Then, the corresponding mode is switched to an idle mode. Authentication is conducted with regard to the corresponding network and is followed by a location registration procedure and a procedure for originating/receiving calls, so a service is used in the corresponding mode. The amount of current used in the idle mode is about 50 mA. It is meant by the initialization process that information necessary for the terminal is selected and that an environment for shifting to the idle mode is created. The initialization process includes a system determination substate, a pilot channel acquisition substate, and a sync channel acquisition substate in this order. The process for initializing a portable terminal is widely known in the art, and a description thereof will be omitted.

Under the control of the control unit 180, the mobile communication modem 113 and the portable Internet modem 123 function independent of their settings. For example, when the portable terminal is in the mobile communication mode and when the mobile communication modem 113 is in a traffic condition, the portable Internet modem 123 is driven to register the location and set up calls with regard to the portable Internet network.

The storage unit 130 has a program region for storing an Operating System (OS), which incorporates a real-time processing function necessary to operate the portable terminal, and software for processing respective functions incorporated by the portable terminal, as well as a data region for storing information or program parameters resulting from driving of the software. The storage unit 130 is connected to the control unit 180, the mobile communication modem 113, and the portable Internet modem 123, respectively, to store data created by corresponding devices. The storage unit 130 may include a flash memory, which is a nonvolatile memory having a high data processing rate.

The input unit 140 has a key matrix structure to create a key value corresponding to a user input and provide the control unit 180 with the value.

The display unit 150 may include a Liquid Crystal Display (LCD). Under the control of the control unit 180, the display unit 150 provides various Graphical User Interfaces (GUIs) for the user. The display unit 150 may also include a vibration motor and a lamp to inform of an incoming call.

The battery unit 160 acts as the power source of the portable terminal and includes a conventional battery and a battery pack.

The power supply unit 170 supplies respective components of the portable terminal with power outputted by the battery unit. If necessary, the power supply unit 170 may supply a specific component with no power under the control of the controller 180.

The controller 180 controls the overall operation of the portable terminal. In particular, the controller 180 transmits control signals to the mobile communication modem 213 or the portable Internet modem 223 and controls their operation so that, according to the type of received RF signals (mobile communication signals and/or portable Internet signals) and/or the type of calls (incoming calls/originating calls), the portable terminal functions in the mobile communication mode or in the portable Internet mode.

When the portable terminal is powered on, the control unit 180 drives the mobile communication modem 113 and the portable Internet modem 123, respectively, to conduct initialization with regard to the mobile communication network and the portable Internet work. The control unit 180 controls the mobile communication modem 113 and the portable Internet modem 123 in such a manner that they can function independent of the settings of the other modem. Therefore, it is possible to control the portable Internet modem 123 to set up a call to the portable Internet network even when a call originates/arrives in the mobile communication mode. When the portable terminal receives a call, the control unit 180 can control the mobile communication modem 113 and/or the portable Internet modem 123 so the portable terminal functions in a network, which transmits a paging message to the portable terminal, between the mobile communication network and the portable Internet network.

In particular, the control unit 180 controls the power supply unit 170 to interrupt power supply to the mobile communication unit 110 when a portable Internet service is provided according to the present invention. The control unit 180 controls the power supply unit 170 to resume power supply to the mobile communication unit 110 when a call is to be connected for the mobile communication service or when the portable Internet service is to be terminated.

Although FIG. 1 shows the mobile communication RF module 111 and the portable Internet RF module 121 as separate components, as well as the mobile communication modem 113, the portable Internet modem 123, and the control unit 180 as separate components, the present invention is not limited to the construction shown in FIG. 1. For example, the mobile communication RF module 111 and the portable Internet RF module 121 may be implemented as a single RF module chip; and the mobile communication modem 113, the portable Internet modem 123, and the control unit 180 may be implemented as a single chip.

The operation of the portable terminal, which is constructed as mentioned above, will now be described with reference to the accompanying drawings.

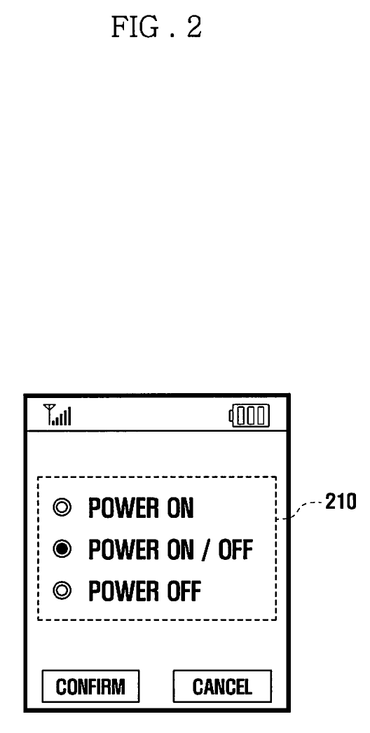

A process for setting up a power saving mode according to the present invention will now be described. FIG. 2 shows a screen for setting up the condition of a portable terminal according to the present invention.

Referring to FIG. 2, the user can set up the power saving mode from the screen example shown in the drawing. The power saving mode includes a PHONE ON mode, a PHONE ON/OFF mode, and a PHONE OFF mode.

In the PHONE ON mode, power is supplied to both the mobile communication unit 110 and the portable Internet unit 120 so the portable terminal uses the portable Internet service, as for a conventional portable terminal.

In the PHONE ON/OFF mode, no power is supplied to the mobile communication unit 110 while the portable terminal is providing the portable Internet service. When a call connection request is received, power supply to the mobile communication unit 110 resumes.

In the PHONE OFF mode, no power is supplied to the mobile communication unit 110 while the portable Internet service is provided. Power supply to the mobile communication unit 110 resumes after the portable Internet service is terminated.

Each mode can be selected by choosing a corresponding one of three radio buttons 210 shown in the screen of FIG. 2 and pressing the confirmation key.

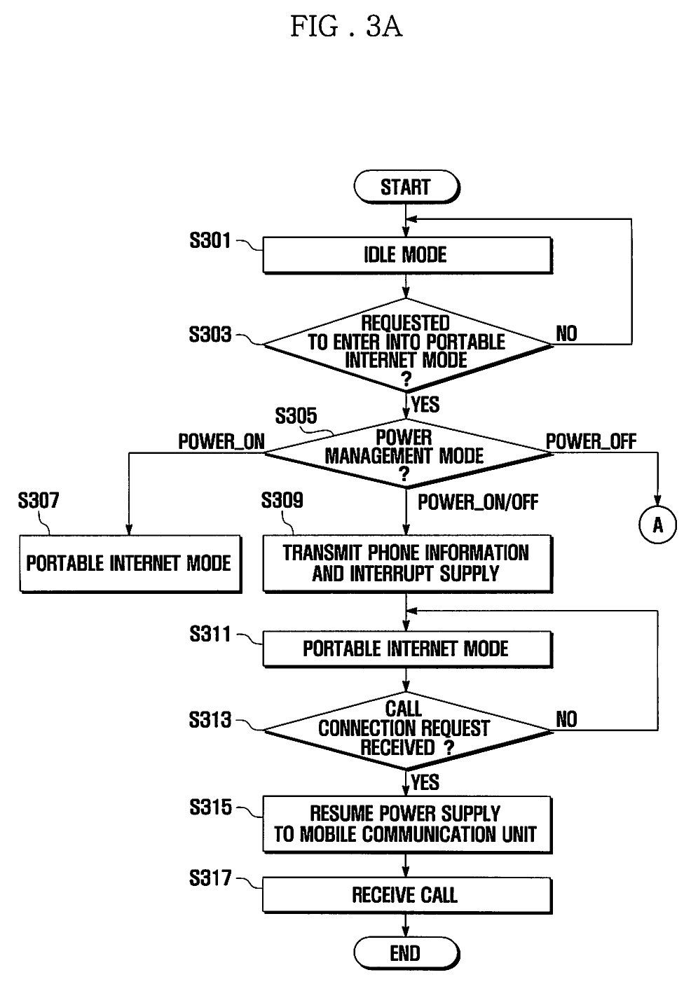

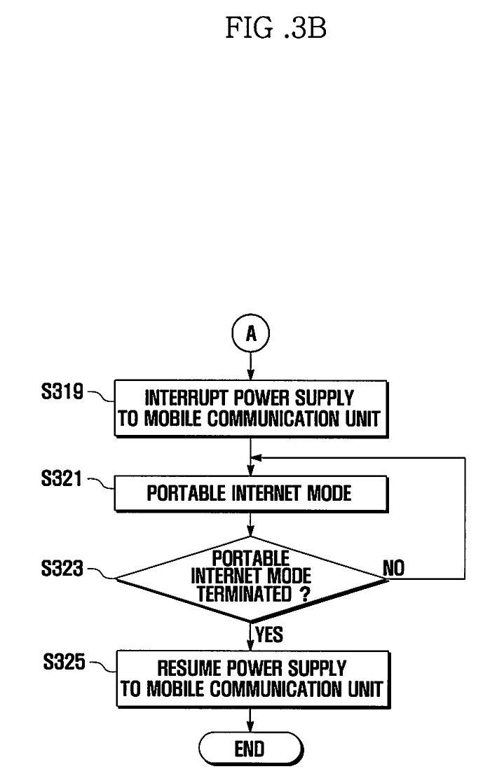

The operation of the portable terminal in each power saving mode will now be described. FIGS. 3A and 3B show the operation of an apparatus for saving the power of a portable terminal according to the present invention.

Referring to FIG. 3A, when the user requests that the portable Internet service be provided while the control unit 180 is in an idle mode in step S301, the control unit 180 detects the request in step S303 and checks the power saving mode in step S305. If it is confirmed as a result of the check that a POWER ON mode has been selected as the power saving mode, the control unit 180 proceeds to S307; in the case of a POWER ON/OFF mode, the control unit 180 proceeds to S309; and, in the case of a POWER OFF mode, the control unit 180 proceeds to step S319 in FIG. 3B. Steps following step S319, which are concerned with operations in the POWER OFF mode, will be described later with reference to FIG. 3B.

After confirming the POWER ON mode, the control unit 180 provides the portable Internet service in step S307, as in the case of a conventional portable terminal. If the POWER ON/OFF mode has been selected, the control unit 180 transmits phone information to the mobile communication base station and the portable Internet base station and interrupts power supply to the mobile communication unit 110 (i.e. powers off the unit 110) in step S309. The phone information includes information necessary to identify the portable terminal and information necessary to identify the base station connected to the portable terminal. Then, the control unit 180 provides the portable Internet service in step S311.

When the portable Internet base station transmits a call connection request, which has been received from the mobile communication base station, while the portable Internet service is provided, the control unit 180 receives the request in step S313 and resumes power supply to the mobile communication unit 110. Then, the control unit 180 connects the call and enters into a speech mode in step S317. As such, power supply to the mobile communication unit 110 is interrupted in the POWER ON/OFF mode, since it is idle in this mode. The power supply resumes only at the call connection request of the mobile communication base station and the portable Internet base station. This reduces power consumption.

The operation of the portable terminal when the POWER OFF mode has been selected as the power saving mode will now be described with reference to FIG. 3B.

Referring to FIG. 3B, if it has been confirmed in step S305 that the POWER OFF mode has been selected as the power saving mode, the control unit 180 interrupts power supply to the mobile communication unit 110 in step S319, and provides the portable Internet service in step S321.

When the portable Internet service is terminated, the control unit 180 detects Internet mode termination in step S323, and resumes power supply to the mobile communication unit 110. As such, when the portable Internet service is provided in the POWER OFF mode, power supply to the mobile communication unit 110 is interrupted; and, after the portable Internet service is terminated, power supply resumes. This reduces power consumption when the portable Internet service is provided.

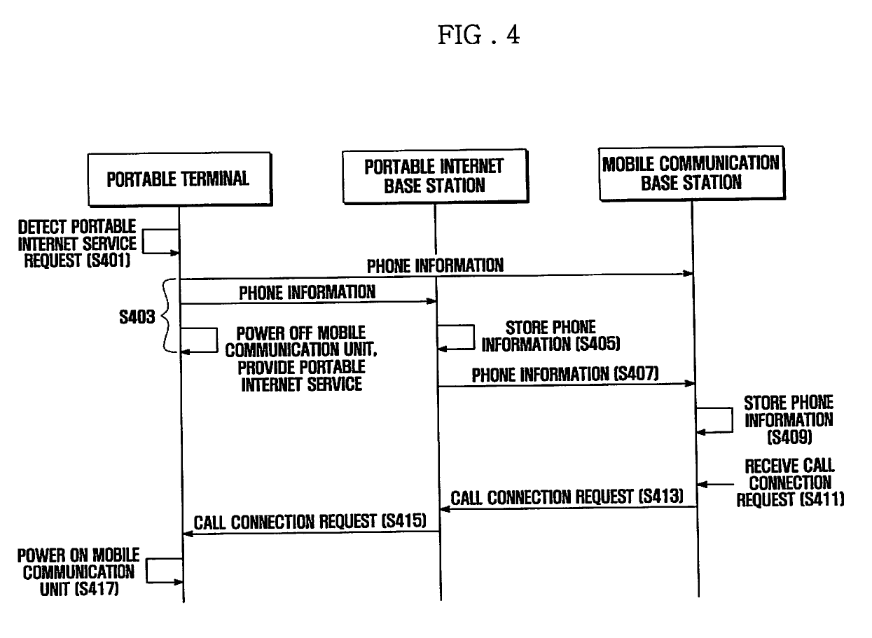

The operation of the portable terminal, the portable Internet base station, and the mobile communication base station according to an embodiment of the present invention will now be described with reference to FIG. 4.

Referring to FIG. 4, if a key input requesting that a portable Internet service be provided is made, the portable terminal detects the request in step S401. The portable terminal transmits phone information to the portable Internet base station and the mobile communication base station and interrupts power supply to the mobile communication unit 110 (i.e. powers off the unit 110) in step S403. The phone information includes information indicating that the portable terminal is in the PHONE ON/OFF mode, as well as information necessary to identify the portable terminal in connection with initialization and call connection when the mobile communication unit is powered off and then powered on. The phone information also includes information necessary to identify the base station connected to the portable terminal.

After receiving the phone information from the portable terminal, the portable Internet base station stores the phone information in step S405, and transmits the phone information to the mobile communication base station to inform that the portable terminal is using the portable Internet base station in step 407.

Upon receiving the phone information from the portable terminal and the portable Internet base station, the mobile communication base station stores the received phone information in step S409. When another portable terminal requests call connection, the mobile communication base station receives the call connection request in step S411, and informs the portable Internet base station of the call connection request in step S413. After receiving the call connection request, the portable Internet base station transmits the call connection request to the portable terminal in step S415. Based on the phone information received from the portable terminal and the portable Internet base station, the mobile communication base station can transmit the call connection request to the portable Internet base station.

After receiving the call connection request from the portable Internet base station, the portable terminal resumes power supply to the mobile communication unit 110 in step S417. Then, the portable terminal turns on the mobile communication unit 110, supplies power to the functional module, and conducts initialization and channel establishment processes, so a mobile communication service is provided.

As apparent from the above description, the present invention is advantageous in that, when the mobile communication service is not provided, power supply to idle components is interrupted. This avoids unnecessary use of the battery and guarantees more efficient use of the portable terminal.

While preferred embodiments of the present invention have been shown and described in this specification, it will be understood by those skilled in the art that various changes or modifications of the embodiments are possible without departing from the spirit and scope of the invention as defined by the appended claims.

What is claimed is:

1. A system for managing power of a portable terminal for using a mobile communication service and a portable Internet service, the system comprising:
a portable terminal having a mobile communication unit and a portable Internet unit for using a mobile communication service and a portable Internet service, respectively, the portable terminal transmitting phone information and interrupting power supply to the mobile communication unit when the portable Internet service is used in a phone on/off mode;
a portable Internet base station for receiving the phone information from the portable terminal, storing the phone information, and transmitting the stored phone information; and
a mobile communication base station for receiving the phone information from the portable Internet base station and the portable terminal, storing the phone information, receiving a call connection request from a different portable terminal, and transmitting the received call connection request, wherein
the portable terminal resumes power supply to the mobile communication unit when the portable Internet base station receives the call connection request and transmits the received call connection request to the portable terminal.

2. The system as claimed in claim 1, wherein the portable terminal interrupts power supply to the mobile communication unit when the portable Internet service is used in a phone off mode, and resumes power supply to the mobile communication unit when the portable Internet service is terminated.

3. The system as claimed in claim 1, wherein the phone information comprises information necessary to identify the portable terminal and information necessary to identify a base station connected to the portable terminal.

4. An apparatus for managing power of a portable terminal for using a mobile communication service and a portable Internet service by using a mobile communication base station and a portable Internet base station, the apparatus comprising:
a mobile communication unit for transmitting/receiving a mobile communication signal according to a protocol defined by a mobile communication service specification;
a portable Internet unit for transmitting/receiving a portable Internet signal according to a protocol defined by a portable Internet service specification; and
a control unit for transmitting phone information to a mobile communication network and the portable Internet base station and interrupting power supply to the mobile communication unit when a portable Internet mode is selected, the control unit resuming power supply to the mobile communication unit when an incoming call request regarding the mobile communication service is received from the portable Internet base station.

5. The apparatus as claimed in claim 4, wherein the control unit limits power supply to the mobile communication unit when the portable Internet mode is selected, and resumes power supply to the mobile communication unit when the portable Internet mode is terminated.

6. The apparatus as claimed in claim 4, wherein the phone information comprises information necessary to identify the portable terminal and information necessary to identify a base station connected to the portable terminal.

7. A method for managing power of a portable terminal for using a mobile communication service and a portable Internet service by using a mobile communication base station and a portable Internet base station, the method comprising the steps of:
monitoring an event occurring when the portable terminal enters into a portable Internet mode;
checking a power saving mode when occurrence of the event has been detected;
transmitting phone information regarding the portable terminal to the mobile communication base station and the portable Internet base station when a phone on/off mode has been confirmed to be the power saving mode, interrupting power supply to the mobile communication unit of the portable terminal, and entering into a portable Internet mode;
monitoring an incoming call request in the portable Internet mode; and
supplying power to the mobile communication unit and entering into a mobile communication mode when the incoming call request has been detected.

8. The method as claimed in claim 7, further comprising:
checking a power saving mode when occurrence of the event has been detected;
interrupting power supply to the mobile communication unit of the portable terminal and entering into the portable Internet mode when a phone off mode has been confirmed to be the power saving mode; and
resuming power supply to the mobile communication unit when the portable Internet mode is terminated.

9. The method as claimed in claim 7, wherein the phone information comprises information necessary to identify the portable terminal and information necessary to identify a base station connected to the portable terminal.

10. A method for managing power of a portable terminal for using a mobile communication service and a portable Internet service, the method comprising the steps of:
monitoring an event occurring when a portable Internet service is provided by a portable terminal;
checking a power saving mode when occurrence of the event is detected by the portable terminal;
transmitting phone information and interrupting power supply to the mobile communication unit when a phone on/off mode has been confirmed to the power saving mode by the portable terminal;
receiving the phone information regarding the portable terminal, storing the phone information, and transmitting the stored phone information by a portable Internet base station;
receiving the phone information from the portable Internet base station and storing the phone information by a mobile communication base station;
monitoring a call connection request of a different portable terminal by the mobile communication base station;
transmitting the call connection request when the mobile communication base station has detected the call connection request;
receiving the call connection request and transmitting the received call connection request by the portable Internet base station; and
receiving the call connection request and resuming power supply to the mobile communication unit by the portable terminal.

11. The method as claimed in claim 10, wherein the phone information comprises information necessary to identify the portable terminal and information necessary to identify a base station connected to the portable terminal.
